(19) United States
(12) Patent Application Publication
(10) Pub. No.: US 2026/0110998 A1
(43) Pub. Date: Apr. 23, 2026

(54) PLC SYSTEM, REMOTE UNIT, AND MASTER STATION

(71) Applicant: Mitsubishi Electric Corporation, Tokyo (JP)

(72) Inventor: Hisashi TAMASHIMA, Tokyo (JP)

(73) Assignee: Mitsubishi Electric Corporation, Tokyo (JP)

(21) Appl. No.: 19/121,821

(22) PCT Filed: Apr. 14, 2023
(86) PCT No.: PCT/JP2023/015253

§ 371 Date: Apr. 17, 2025

(51) Int. Cl. G05B 19/05

(52) U.S. Cl. CPC G05B 19/052; G05B 2219/1109

(57) ABSTRACT

Each of remote units includes an operation mode setter to set an operation mode based on an operation performed by a user, a connection combination determiner to determine a connection combination of a base unit and an expansion unit based on the set operation mode, and a unit information notifier to provide unit information including connection combination information. A master station includes an internet protocol assigner to assign an internet protocol address to each of the remote units based on the unit information acquired by a unit information acquirer and network structure information, and a transmission-reception information determiner to determine formats of information to be transmitted and received by the master station based on the network structure information updated by a network structure information updater.

### TECHNICAL FIELD

The present disclosure relates to a programmable logic controller (PLC) system, a remote unit, a master station, a remote unit control method, a master station control method, a remote unit control program, and a master station control program.

### BACKGROUND ART

A PLC system used for a production line at a factory includes multiple types of units including a central processing unit (CPU) that executes a control program for controlling inputs into and outputs from devices. When one of the multiple types of units fails in the PLC system, the failed unit is to be promptly replaced to restore the system.

Patent Literature 1 describes a PLC unit system including a master unit that connects the CPU to a network, and multiple units such as representative units and subordinate units connected to the master unit. In the PLC unit system described in Patent Literature 1, a personal computer (PC) including an engineering tool connected to the CPU presets, for the CPU, the above multiple units as virtual units that can replace the failed unit to simplify the operation to replace the failed unit and reduce the operation time.

### CITATION LIST

### Patent Literature

Patent Literature 1: International Publication No. WO 2020/079730

### SUMMARY OF INVENTION

### Technical Problem

When a unit with a capability of communicating with the master unit through the network fails in the PLC unit system described in Patent Literature 1, the failed unit can be replaced by another unit with the capability of communicating with the master unit. In such a PLC unit system, an expansion unit may be connected to the unit to increase the number of devices that undergo input and output control. Such an expansion unit has no communication capability, similarly to the CPU. Thus, when a unit with no communication capability, such as the expansion unit, fails in the PLC unit system described in Patent Literature 1, the failed unit with no communication capability may not be easily replaced by the other unit with the communication capability.

Under such circumstances, an objective of the present disclosure is to allow a unit with the communication capability to easily replace a unit with no communication capability.

### Solution to Problem

To achieve the above objective, a programmable logic controller system according to an aspect of the present disclosure includes a master station including a central processing unit and a master unit, and a plurality of remote units to transmit and receive information to and from the master station through a network. The central processing unit controls devices connected to the plurality of remote units. Each of the plurality of remote units includes an operation mode setter, a connection combination determiner, and a unit information notifier. The operation mode setter sets an operation mode to one of a base mode or an expansion mode based on an operation performed by a user. The base mode is an operation mode in which the remote unit operates as a base unit connected to the network to transmit and receive information to and from the master station, and the expansion mode is an operation mode in which the remote unit operates as an expansion unit for the base unit. The connection combination determiner determines, based on the operation mode set by the operation mode setter, a connection combination of a base unit and an expansion unit. The unit information notifier provides, to the master station, unit information about the remote unit. The unit information includes connection combination information for identifying the connection combination determined by the connection combination determiner. The master station includes a unit information acquirer, an internet protocol address assigner, a network structure information updater, and a transmission-reception information determiner. The unit information acquirer acquires the unit information of a remote unit of the plurality of remote units. The internet protocol address assigner assigns an internet protocol address to the remote unit based on the unit information acquired by the unit information acquirer and network structure information indicating a structure of the network. The network structure information updater updates the network structure information based on the internet protocol address assigned by the internet protocol address assigner and the unit information acquired by the unit information acquirer. The transmission-reception information determiner determines, based on the network structure information updated by the network structure information updater, a format of information to be transmitted by the master station to the remote unit and a format of information to be received by the master station from the remote unit.

### Advantageous Effects of Invention

Each of the remote units according to the above aspect of the present disclosure sets the operation mode to the base mode or the expansion mode, determines the connection combination of the base unit and the expansion unit, and provides the unit information including the connection combination information to the master station. The master station assigns the IP address to each of the remote units based on the acquired unit information, updates the network structure information, and determines the formats of information to be transmitted and received by the master station. Thus, when the remote unit with the communication capability is set in the expansion mode and replaces the expansion unit with no communication capability in the PLC system according to the above aspect of the present disclosure, the master station can transmit and receive information to and from the remote unit after replacement in the same manner as with the expansion unit before replacement. Thus, in the PLC system according to the above aspect of the present disclosure, a unit with the communication capability can replace a unit with no communication capability more easily than in a PLC system including a master station and remote units with no communication capability described above.

### BRIEF DESCRIPTION OF DRAWINGS

FIG. 1 is a functional block diagram of a PLC system according to Embodiment 1;

FIG. 2 is a block diagram of each of a master station and remote units according to Embodiment 1, illustrating the hardware configuration;

FIG. 3 is a diagram describing replacement of an expansion unit and a remote unit in Embodiment 1;

FIG. 4 is a timing chart of transmission and reception of information when the master station according to Embodiment 1 assigns an IP address to a remote unit;

FIG. 5A is a diagram of a display example of network structure information in Embodiment 1 before update;

FIG. 5B is a diagram of a display example of the network structure information in Embodiment 1 after the update;

FIG. 6 is a flowchart of a unit information notification process in Embodiment 1;

FIG. 7 is a flowchart of a transmission-reception information determination process in Embodiment 1;

FIG. 8 is a functional block diagram of a PLC system according to Embodiment 2;

FIG. 9 is a diagram of a display example of parameter information in Embodiment 2;

FIG. 10 is a flowchart of a parameter information transmission process in Embodiment 2;

FIG. 11A is a diagram of a modification example of the network structure information before update;

FIG. 11B is a diagram of a modification example of the network structure information after the update; and

FIG. 12 is a diagram of a modification example of the parameter information.

### DESCRIPTION OF EMBODIMENTS

A programmable logic controller (PLC) system according to one or more embodiments of the present disclosure is described in detail below with reference to the drawings. Like reference signs denote like or corresponding components in the drawings.

### Embodiment 1

PLC System 1 according to Embodiment 1

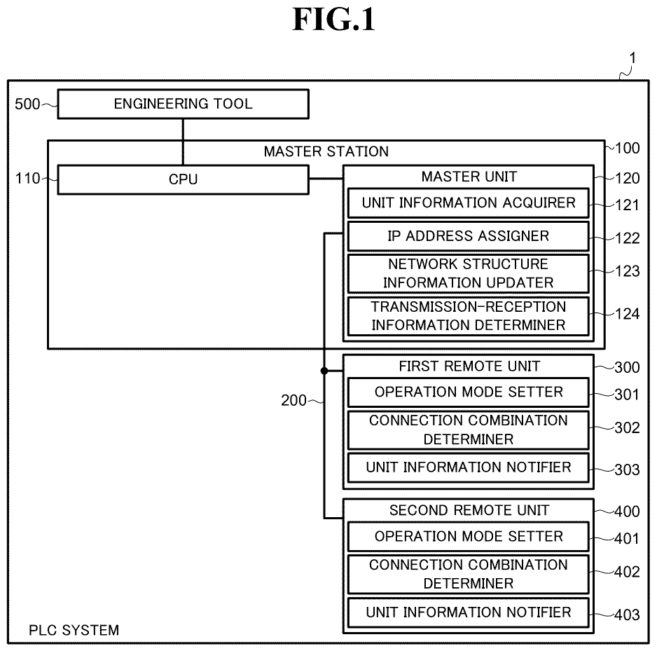

A PLC system 1 according to Embodiment 1 of the present disclosure is, for example, a sequence control system or a sequencer system including multiple types of units, including a central processing unit (CPU) 110 (described later) that executes a device control program for controlling inputs into and outputs from devices in a production line at a factory. As illustrated in FIG. 1, the PLC system 1 includes a master station 100, and a first remote unit 300 and a second remote unit 400 that are example remote units connected to the master station 100 with a field network 200 that is an example network.

### Master Station 100 According to Embodiment 1

The master station 100 includes the CPU 110 described above and a master unit 120 that connects the CPU 110 to the field network 200. An engineering tool 500 (described later) is connected to the CPU 110 with a universal serial bus (USB). The engineering tool 500 in the present embodiment is connected to the CPU 110 with the USB, but the structure is not limited to this example. For example, the engineering tool 500 may be connected to the CPU 110 through the Internet with Ethernet (registered trademark).

In this example, the engineering tool 500 is a computer with an engineering tool program installed. The engineering tool 500 generates multiple types of information, such as the device control program described above, parameter information indicating a parameter to be used by each of the CPU 110, the master unit 120, the first remote unit 300, and the second remote unit 400, and network structure information (described later) indicating the structure of the field network 200. The engineering tool 500 transmits the multiple types of information to the CPU 110. The CPU 110 can thus control each of the master unit 120, the first remote unit 300, and the second remote unit 400 using, for example, the device control program and the parameter information received from the engineering tool 500 to control inputs into and outputs from devices connected to the first remote unit 300 or the second remote unit 400.

The master unit 120 transmits and receives information to and from the first and second remote units 300 and 400 through the field network 200 based on the parameter information and the network structure information (described later) received by the CPU 110 from the engineering tool 500. The master unit 120 includes a unit information acquirer 121 that acquires unit information (described later), an internet protocol (IP) address assigner 122 that assigns an IP address to each of the first and second remote units 300 and 400, and a network structure information updater 123 that updates the network structure information (described later). The master unit 120 also includes a transmission-reception information determiner 124 that determines the formats of information to be transmitted and received between the master station 100 and each of the first and second remote units 300 and 400.

### First Remote Unit 300 and Second Remote Unit 400 According to Embodiment 1

Each of the first and second remote units 300 and 400 controls inputs into and outputs from devices connected to the first or second remote unit 300 or 400. More specifically, each of the first and second remote units 300 and 400 transmits, through the field network 200, information input from an input device such as a sensor or a switch (not illustrated) to the master station 100. The sensor or the switch is an example device connected to the first or second remote unit 300 or 400. Each of the first and second remote units 300 and 400 also outputs, through the field network 200, information received from the master station 100 to an output device such as a capacitor or a driver (not illustrated). The capacitor or the driver is an example device connected to the first or second remote unit 300 or 400. Each of the first and second remote units 300 and 400 includes an operation mode setter 301 or 401 that sets an operation mode (described later), a connection combination determiner 302 or 402 that determines a connection combination of the remote units, and a unit information notifier 303 or 403 that provides the unit information (described later).

### Hardware Configuration of Master Station 100 According to Embodiment 1

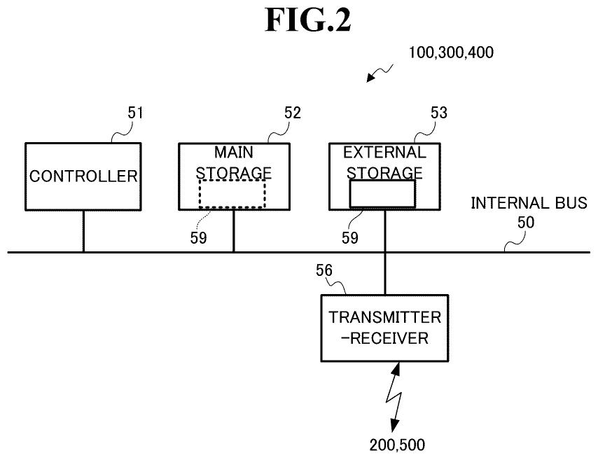

As illustrated in FIG. 2, the master station 100 includes a controller 51 that performs processes based on a control program 59. The controller 51 includes a CPU. The controller 51 functions as the IP address assigner 122, the network structure information updater 123, and the transmission-reception information determiner 124 in FIG. 1 based on the control program 59.

Referring back to FIG. 2, the master station 100 includes a main storage 52 into which the control program 59 is loaded. The main storage 52 is used as a work area for the controller 51. The main storage 52 includes a volatile storage such as a random-access memory (RAM).

The master station 100 also includes an external storage 53 that prestores the control program 59. The external storage 53 provides data stored in the program to the controller 51 based on an instruction from the controller 51, and stores data provided from the controller 51. The external storage 53 includes a non-volatile storage such as a flash memory, a hard disk drive (HDD), or a solid-state drive (SSD).

The master station 100 also includes a transmitter-receiver 56 that transmits and receives information. The transmitter-receiver 56 includes information communication components such as a communication network termination device or a wireless communication device connected to a network. The transmitter-receiver 56 functions as the unit information acquirer 121 in FIG. 1.

Referring back to FIG. 2, the main storage 52, the external storage 53, and the transmitter-receiver 56 in the master station 100 are connected to the controller 51 with an internal bus 50.

The master station 100 implements the functions of the unit information acquirer 121, the IP address assigner 122, the network structure information updater 123, and the transmission-reception information determiner 124 in FIG. 1, with the controller 51 using the main storage 52, the external storage 53, and the transmitter-receiver 56 as resources. For example, the master station 100 performs acquiring the unit information with the unit information acquirer 121, and assigning an IP address with the IP address assigner 122. For example, the master station 100 performs updating the network structure information with the network structure information updater 123, and determining the formats of information to be transmitted and received with the transmission-reception information determiner 124.

### Hardware Configurations of First Remote Unit 300 and Second Remote Unit 400 According to Embodiment 1

Similarly to the master station 100, each of the first and second remote units 300 and 400 includes the controller 51, as well as the main storage 52, the external storage 53, and the transmitter-receiver 56 connected to the controller 51 with the internal bus 50. The controller 51 in each of the first and second remote units 300 and 400 functions as the operation mode setter 301 or 401 and the connection combination determiner 302 or 402 in FIG. 1 based on the control program 59. The transmitter-receiver 56 in each of the first and second remote units 300 and 400 functions as the unit information notifier 303 or 403 in FIG. 1.

Each of the first and second remote units 300 and 400 performs the functions of the operation mode setter 301 or 401, the connection combination determiner 302 or 402, and the unit information notifier 303 or 403 in FIG. 1, with the controller 51 using the main storage 52, the external storage 53, and the transmitter-receiver 56 as resources. For example, each of the first and second remote units 300 and 400 performs setting the operation mode with the operation mode setter 301 or 401, and determining the connection combination with the connection combination determiner 302 or 402. For example, each of the first and second remote units 300 and 400 performs providing the unit information with the unit information notifier 303 or 403.

### Details of Functional Components of First Remote Unit 300 and Second Remote Unit 400 According to Embodiment 1

Referring back to FIG. 1, each of the operation mode setters 301 and 401 sets the operation mode to one of a base mode or an expansion mode based on a signal output, through an operation performed by a user, from an operation-mode setting hardware (H/W) switch (not illustrated). The base mode is an operation mode in which the first or second remote unit 300 or 400 operates as a base unit connected to the field network 200 to transmit and receive information to and from the master station 100. The expansion mode is an operation mode in which the first or second remote unit 300 or 400 operates as an expansion unit for the base unit. The operation-mode setting H/W switch is included in each of the first and second remote units 300 and 400.

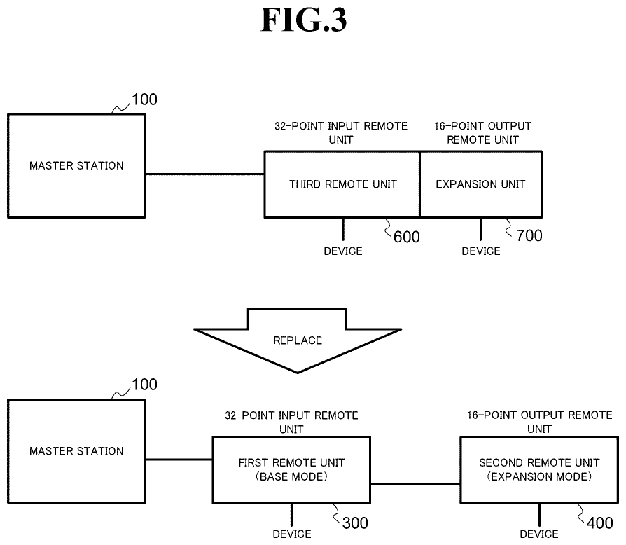

In an example, as illustrated in FIG. 3, a third remote unit 600 is connected to the master station with the field network 200, and an expansion unit 700 is connected to the third remote unit 600. In this example, the third remote unit 600 and the expansion unit 700 fail. The third remote unit 600 is a 32-point input remote unit that can input information received from the master station 100 into 32 different devices connected to the third remote unit 600. The expansion unit 700 is a 16-point output remote unit that can transmit, to the master station 100, information output from 16 different devices connected to the expansion unit 700.

In this case, the first remote unit 300 sets the operation mode to the base mode to replace the failed third remote unit 600. The second remote unit 400 sets the operation mode to the expansion mode to replace the failed expansion unit 700.

In this case, the first remote unit 300 is to be connectable to the same number of or a greater number of input devices and output devices than the failed third remote unit 600. In other words, the failed single third remote unit 600 is to be replaced by a single first remote unit 300 having capabilities comparable to or higher than the failed third remote unit 600. More specifically, the first remote unit 300 is to be a 32-point input remote unit similarly to the third remote unit 600.

In contrast, the second remote unit 400 may be connectable to a fewer number of input devices and output devices than the failed expansion unit 700. In this case, the failed expansion unit 700 may be replaced by multiple types of remote units including the second remote unit 400. In other words, the failed single expansion unit 700 may be replaced by multiple types of remote units. For example, the second remote unit 400 may be a 16-point output remote unit similarly to the expansion unit 700, or may be an 8-point output remote unit to replace the expansion unit 700 with two 8-point output remote units including the second remote unit 400.

Although not illustrated, when, for example, the single expansion unit 700 among multiple expansion units connected to the third remote unit 600 fails and is thus to be replaced, the second remote unit 400 may set the operation mode to the expansion mode to replace the multiple expansion units. In other words, the multiple expansion units may be replaced by the single second remote unit 400 having capabilities comparable to or higher than the multiple expansion units. For example, two expansion units 700 being two 8-point output remote units may be replaced by the second remote unit 400 being a 16-point output remote unit.

Referring back to FIG. 1, each of the connection combination determiners 302 and 402 determines the connection combination of the base unit and the expansion unit based on the operation modes of the first and second remote units 300 and 400 set by the operation mode setters 301 and 401 and a signal output from, through an operation performed by the user, a connection-combination determination H/W switch (not illustrated). For example, each of the connection combination determiners 302 and 402 determines to connect the first remote unit 300 that is the base unit with the operation mode set to the base mode to the second remote unit 300 that is the expansion unit with the operation mode set to the expansion mode. The connection-combination determination H/W switch is included in each of the first and second remote units 300 and 400, similarly to the operation-mode setting H/W switch.

Each of the connection combination determiners 302 and 402 uses information for uniquely identifying the first or second remote unit 300 or 400, such as the current IP address of the first or second remote unit 300 or 400, to generate connection combination information for identifying the determined connection combination. For example, when the current IP address of the first remote unit 300 is 192.168.3.1, the connection combination information of the second remote unit 400 that is the expansion unit includes information for identifying the IP address of the base unit as 192.168.3.1.

Each of the unit information notifiers 303 and 403 transmits the unit information about the first or second remote unit 300 or 400 to the master station 100 to provide the unit information to the master station 100. The unit information is generated by each of the first and second remote units 300 and 400 and includes, for example, the connection combination information of the first or second remote unit 300 or 400 generated by the connection combination determiner 302 or 402, information for identifying the unit type of the first or second remote unit 300 or 400, and information for identifying the number of input devices and output devices connectable to the first or second remote unit 300 or 400.

### Details of Functional Components of Master Station 100 According to Embodiment 1

The unit information acquirer 121 receives the unit information transmitted from each of the first and second remote units 300 and 400 to acquire the unit information of the first and second remote units 300 and 400.

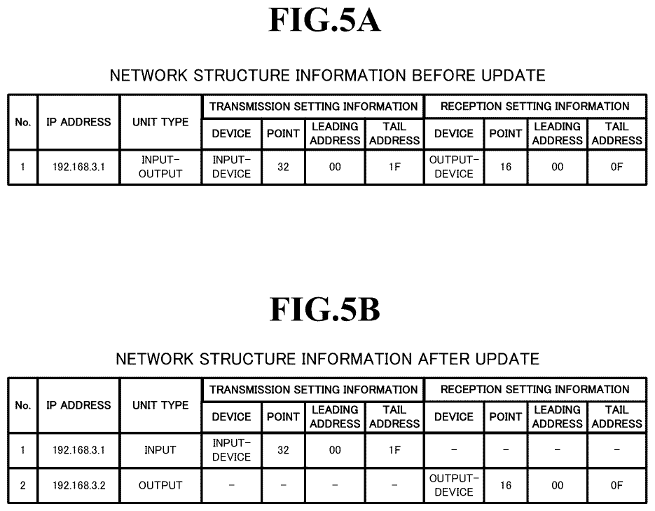

The IP address assigner 122 assigns the IP address to each of the first and second remote units 300 and 400 based on the unit information acquired by the unit information acquirer 121 and the network structure information received by the CPU 110 from the engineering tool 500. The network structure information includes IP address information indicating the IP address, unit type information indicating the unit type, transmission setting information, and reception setting information that are grouped for each unit connected to the field network 200. The transmission setting information and the reception setting information set details of information transmitted from and received by the master station 100. As illustrated in FIG. 5A, for example, the network structure information can be displayed in a form of a table.

As illustrated in FIG. 5A, in the network structure information received by the master station 100 from the engineering tool 500, for example, the value of a number being identification information of the third remote unit 600 is 1. In the network structure information, for example, the value of an IP address being the IP address information of the third remote unit 600 is 192.168.3.1, and the value of a unit type being the unit type information of the third remote unit 600 is an input-output. For a digital input-output (I/O) unit such as the third remote unit 600, the value of the unit type may be an input or an output other than the input-output. When the third remote unit 600 is, for example, an analog I/O unit, the value of the unit type is an analog input or an analog output.

In the transmission setting information of the third remote unit 600 included in the network structure information, for example, the value of a device indicating the type of devices in which information transmitted from the master station 100 is input is an input-device. In the transmission setting information of the third remote unit 600 included in the network structure information, for example, the value of a point indicating the number of the devices into which information transmitted from the master station 100 is input is 32, the value of a leading address being the leading address of the devices is 00, and the value of a tail address being the tail address of the devices is 1F.

In the reception setting information of the third remote unit 600 included in the network structure information, for example, the value of the device indicating the type of devices that output information to be received by the master station 100 is an output-device. In the reception setting information of the third remote unit 600 included in the network structure information, for example, the value of the point being the number of the devices that output information to be received by the master station 100 is 16, the value of the leading address being the leading address of the devices is 00, and the value of the tail address being the tail address of the devices is 0F.

Referring back to FIG. 1, the IP address assigner 122 may assign, for example, the IP address of the third remote unit 600 to the first remote unit 300 replacing the third remote unit 600.

The master station 100 cannot transmit or receive information to or from a remote unit with an IP address not included in the network structure information. The master station 100 is thus to identify the IP address of a remote unit with the operation mode set to the expansion mode. However, when the remote unit has already determined the IP address, the determined IP address may overlap the IP address of another remote unit included in the network structure information. In this case, the master station 100 cannot transmit or receive information to or from the remote unit with the operation mode set to the expansion mode. For example, when the IP address of the second remote unit 400 with the operation mode set to the expansion mode overlaps the IP address of another remote unit in the network structure information, the master station 100 cannot transmit or receive information to or from the second remote unit 400.

Thus, the IP address assigner 122 identifies an unused IP address that is not included in the network structure information and dynamically assigns the unused IP address to the remote unit with the operation mode set to the expansion mode. More specifically, the IP address assigner 122 uses a dynamic host configuration protocol (DHCP) to assign the IP address to the second remote unit 400. In other words, the master station 100 functions as a DHCP server with the IP address assigner 122 to assign the IP address to the second remote unit 400.

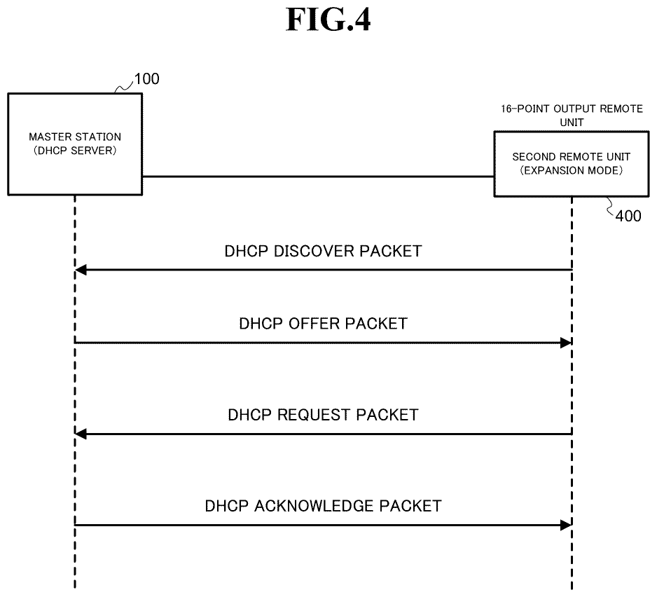

As illustrated in FIG. 4, for example, when the operation mode is set to the expansion mode, the second remote unit 400 first causes the transmitter-receiver 56 in FIG. 2 to transmit a DHCP discover packet to all units in the field network 200 to identify the master station 100. When the transmitter-receiver 56 in the master station 100 receives the DHCP discover packet, the IP address assigner 122 identifies an unused IP address from the network structure information stored in the master station 100. The IP address assigner 122 then causes the transmitter-receiver 56 to transmit a DHCP offer packet for identifying the IP address to the second remote unit 400. In this manner, the IP address assigner 122 proposes the IP address, or more specifically, an unused IP address of 192.168.3.2 to the second remote unit 400.

When receiving the DHCP offer packet, the second remote unit 400 causes the transmitter-receiver 56 to transmit, to the master station 100, a DHCP request packet indicating a request to allocate the proposed IP address. When the transmitter-receiver 56 in the master station 100 receives the DHCP request packet, the IP address assigner 122 causes the transmitter-receiver 56 to transmit, to the second remote unit 400, a DHCP acknowledge packet indicating an approval of the allocation. In this manner, the proposed IP address is assigned to the second remote unit 400.

Referring back to FIG. 1, the network structure information updater 123 updates the network structure information based on the IP address assigned by the IP address assigner 122 and the unit information acquired by the unit information acquirer 121. After the IP address assigner 122 assigns the IP address to the second remote unit 400, the network structure information updater 123 updates the network structure information based on the IP address of each of the first and second remote units 300 and 400, the connection combination information of each of the first and second remote units 300 and 400 included in the unit information, the information for identifying the unit type of each of the first and second remote units 300 and 400, and the information for identifying the number of input devices and output devices connectable to each of the first and second remote units 300 and 400.

As illustrated in FIG. 5B, in the updated network structure information, for example, the value of the number being the identification information of the first remote unit 300 that has replaced the third remote unit 600 is 1, and the value of the number being the identification information of the second remote unit 400 that has replaced the expansion unit 700 is 2. In the updated network structure information, for example, the value of the IP address being the IP address information of the first remote unit 300 is 192.168.3.1, and the value of the IP address being the IP address information of the second remote unit 400 is 192.168.3.2.

In the updated network structure information, for example, the value of the unit type being the unit type information of the first remote unit 300 is the input, and the value of the unit type being the unit type information of the second remote unit 400 is the output. In the transmission setting information of the first remote unit 300 included in the updated network structure information, for example, the value of the device is the input-device, the value of the point is 32, the value of the leading address being the leading address of the devices is 00, and the value of the tail address being the tail address of the devices is 1F. Thus, the transmission setting information of the first remote unit 300 in the updated network structure information is not changed from the transmission setting information of the third remote unit 600 in pre-update network structure information.

In the reception setting information of the second remote unit 400 included in the updated network structure information, for example, the value of the device is the output-device, the value of the point is 16, the value of the leading address being the leading address of the devices is 00, and the value of the tail address being the tail address of the devices is 0F. Thus, the reception setting information of the second remote unit 400 in the updated network structure information is not changed from the reception setting information of the third remote unit 600 in the pre-update network structure information.

Referring back to FIG. 1, the transmission-reception information determiner 124 determines, based on the network structure information updated by the network structure information updater 123, the format of information to be transmitted by the master station 100 to each of the first and second remote units 300 and 400 and the format of information to be received by the master station 100 from each of the first and second remote units 300 and 400. The master station 100 transmits and receives, based on the updated network structure information and the formats of information determined by the transmission-reception information determiner 124, information to and from each of the first and second remote units 300 and 400 to allow information to be input into and output from the devices connected to each of the first and second remote units 300 and 400.

### Unit Information Notification Process in Embodiment 1

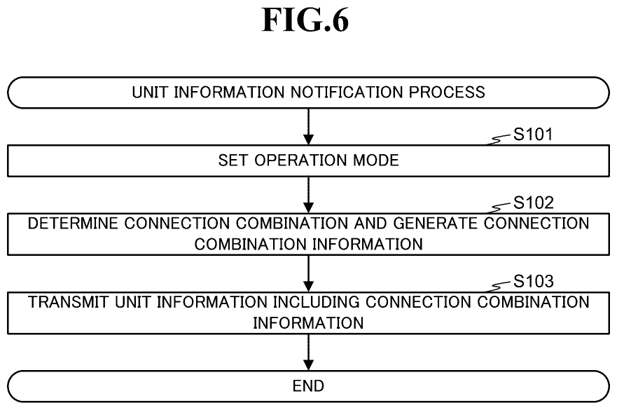

An operation for providing the unit information to the master station 100 when the first remote unit 300 replaces the third remote unit 600 and the second remote unit 400 replaces the expansion unit 700 is now described with reference to a flowchart. For example, when being turned on after replacing the third remote unit 600 and the expansion unit 700, each of the first and second remote units 300 and 400 starts performing a unit information notification process illustrated in FIG. 6.

As illustrated in FIG. 6, each of the operation mode setters 301 and 401 first sets the operation mode to one of the base mode or the expansion mode based on the signal from the H/W switch (step S101). For example, the operation mode setter 301 in the first remote unit 300 sets the operation mode to the base mode, and the operation mode setter 401 in the second remote unit 400 sets the operation mode to the expansion mode based on the signal from the H/W switch.

After the operation modes are set, each of the connection combination determiners 302 and 402 determines the connection combination of the base unit and the expansion unit based on the operation modes set to the first and second remote units 300 and 400, and generates the connection combination information (step S102). For example, each of the connection combination determiners 302 and 402 determines, based on the signal from the H/W switch, to connect the first remote unit 300 with the operation mode set to the base mode and the second remote unit 300 with the operation mode set to the expansion mode, and generates the connection combination information.

After the connection combination information is generated, each of the unit information notifiers 303 and 403 transmits, to the master station 100, the unit information of the first or second remote unit 300 or 400 including the generated connection combination information to provide the unit information to the master station 100 (step S103), and ends the process. For example, each of the unit information notifiers 303 and 403 transmits, to the master station 100, the unit information including the connection combination information generated by the first or second remote unit 300 or 400, the information for identifying the unit type, and the information for identifying the number of connectable devices.

### Transmission-reception Information Determination Process in Embodiment 1

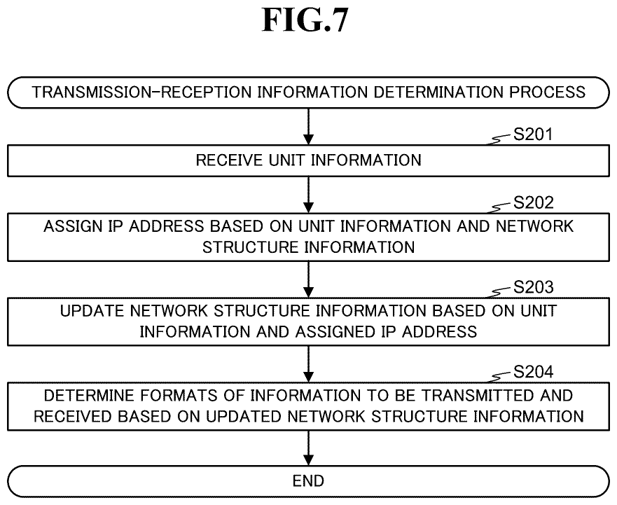

An operation for determining the formats of information to be transmitted and received by the master station 100 to and from each of the first and second remote units 300 and 400 after replacement is now described with reference to a flowchart. For example, when each of the first and second remote units 300 and 400 is turned on after replacement, the master station 100 starts a transmission-reception information determination process illustrated in FIG. 7.

As illustrated in FIG. 7, the unit information acquirer 121 first receives the unit information transmitted from each of the first and second remote units 300 and 400 to acquire the unit information (step S201). The IP address assigner 122 assigns the IP address to each of the first and second remote units 300 and 400 based on the acquired unit information and the network structure information stored in the master station 100 (step S202). For example, the IP address assigner 122 assigns the IP address of the third remote unit 600, or 192.168.3.1, to the first remote unit 300 that has replaced the third remote unit 600, and assigns, with the DHCP illustrated in FIG. 4, an unused IP address of 192.168.3.2 to the second remote unit 400.

After the IP addresses are assigned, the network structure information updater 123 updates the network structure information based on the assigned IP addresses and the acquired sets of unit information (step S203). For example, the network structure information updater 123 updates the pre-update network structure information illustrated in FIG. 5A to the updated network structure information illustrated in FIG. 5B. After the network structure information is updated, the transmission-reception information determiner 124 determines, based on the updated network structure information, the format of information to be transmitted by the master station 100 to each of the first and second remote units 300 and 400 and the format of information to be received by the master station 100 from each of the first and second remote units 300 and 400 (step S204), and ends the process.

As described above, the master station 100 in the PLC system 1 according to the present embodiment includes the CPU 110 and the master unit 120. The master unit 120 can transmit and receive information to and from the first, second, and third remote units 300, 400, and 600 connected to the field network 200. This allows the CPU 110 to control the devices connected to each of the first, second, and third remote units 300, 400, and 600.

The first and second remote units 300 and 400 can replace the third remote unit 600 and the expansion unit 700. In each of the first and second remote units 300 and 400, the operation mode setter 301 or 401 sets the operation mode to one of the base mode or the expansion mode based on an operation performed by the user, and the connection combination determiner 302 or 402 determines the connection combination of the base unit and the expansion unit based on the set operation modes. In each of the first and second remote units 300 and 400, the unit information notifier 303 or 403 provides the unit information including the connection combination information to the master station 100.

In the master station 100, the unit information acquirer 121 acquires the unit information, and the IP address assigner 122 assigns the IP address to each of the first and second remote units 300 and 400 based on the acquired unit information and the network structure information stored in the master station 100. In the master station 100, the network structure information updater 123 updates the network structure information based on the assigned IP addresses and the acquired sets of unit information. Further, in the master station 100, the transmission-reception information determiner 124 determines, based on the updated network structure information, the format of information to be transmitted by the master station 100 to each of the first and second remote units 300 and 400 and the format of information to be received by the master station 100 from each of the first and second remote units 300 and 400.

In this manner, when the second remote unit 400 with the communication capability is set in the expansion mode and replaces the expansion unit 700 with no communication capability, the master station 100 can transmit and receive information to and from the second remote unit 400 after replacement in the same manner as with the expansion unit 700 before replacement. Thus, in the PLC system 1 according to the present embodiment, a unit with the communication capability can replace a unit with no communication capability more easily than in a PLC system including a master station and remote units without the capabilities described above.

In a known PLC system such as the PLC system described in Patent Literature 1, when an expansion unit fails and is to be replaced, the failed expansion unit is typically replaced by a unit of the same type as the failed expansion unit. However, the user may not have a spare expansion unit of the same type and may not acquire the expansion unit promptly after ordering due to a long delivery time or discontinued production. In such a case, the user may replace the failed expansion unit with a base unit to promptly perform placement and restore the system.

In this case, the user is to update, after replacement, various information items such as the control program, the parameter information, and the network structure information using the engineering tool, and connect the engineering tool to the CPU to transmit the updated information items. Thus, when replacing an expansion unit with no communication capability with a base unit with the communication capability in the known PLC system, the user is to be knowledgeable about the information update using the engineering tool. Further, such replacement in the known PLC system is laborious for the knowledgeable user and increases the workload of the user.

For the known PLC system, the engineering tool may not be installed to the location of the PLC system due to reasons such as security, and may not be connected to the CPU. In this case, the system cannot be restored promptly.

In contrast, in the PLC system 1 according to the present embodiment, each of the first and second remote units 300 and 400 sets the operation mode based on the signal from the H/W switch included in the first or second remote unit 300 or 400, determines the connection combination, and provides the unit information to the master station. The master station assigns the IP address to each of the first and second remote units 300 and 400 based on the acquired unit information and the information stored in the master station, updates the network structure information, and determines the formats of information to be transmitted and received by the master station.

Thus, in the PLC system 1 according to the present embodiment, the master station can transmit and receive information to and from the second remote unit 400 that has replaced the expansion unit 700 without the user updating information with the engineering tool 500, connecting the engineering tool 500 to the CPU 110, or transmitting the updated information to the CPU 110. Thus, in the PLC system 1 according to the present embodiment, the second remote unit 400 with the communication capability can replace the expansion unit 700 with no communication capability more easily than in the known PLC system, allowing the user to restore the PLC system 1 promptly.

### Embodiment 2

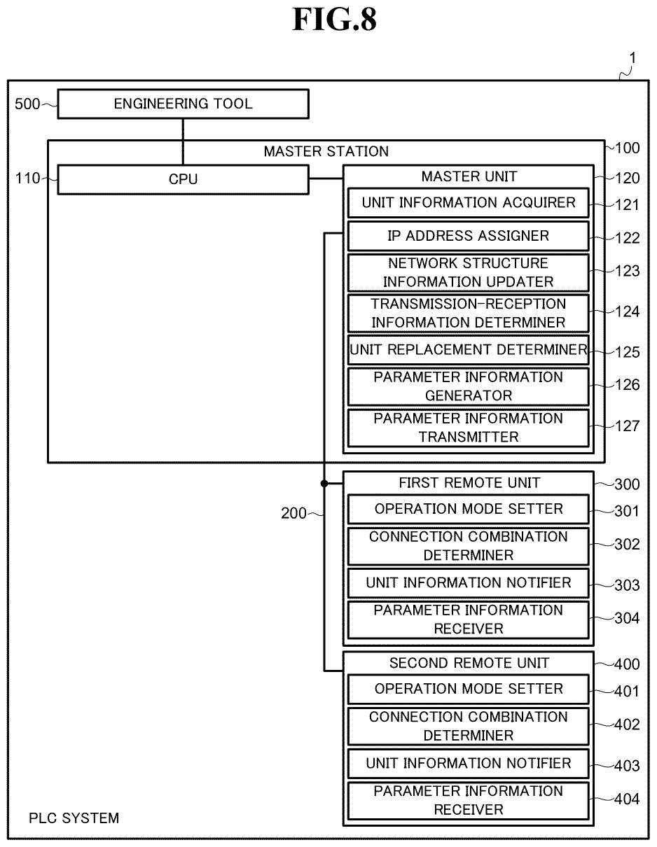

In Embodiment 1, each of the operation mode setters 301 and 401 sets the operation mode based on the signal from the H/W switch, and each of the connection combination determiners 302 and 402 determines the connection combination based on the signal from the H/W switch. However, the structure is not limited to this example. For example, the master station may generate the parameter information to be used to set the operation mode and determine the connection combination. A PLC system 1 according to Embodiment 2 is now described in detail with reference to FIGS. 8 to 10.

In Embodiment 2, components different from those in Embodiment 1 are described, and the same components as in Embodiment 1 are not described to avoid redundancy.

### Master Station 100 According to Embodiment 2

As illustrated in FIG. 8, the master station 100 in the PLC system 1 according to the present embodiment additionally includes a unit replacement determiner 125 that determines whether a remote unit is replaceable by another remote unit, a parameter information generator 126 that generates the parameter information, and a parameter information transmitter 127 that transmits the parameter information.

### First Remote Unit 300 and Second Remote Unit 400 According to Embodiment 2

Each of the first and second remote units 300 and 400 in the PLC system 1 according to the present embodiment additionally includes a parameter information receiver 304 or 404 that receives the parameter information. In the present embodiment, each of the first and second remote units 300 and 400 does not include the operation-mode setting H/W switch and the connection-combination determination H/W switch.

### Hardware Configuration of Master Station 100 According to Embodiment 2

As illustrated in FIG. 2, the controller 51 in the master station 100 functions as the unit replacement determiner 125 and the parameter information generator 126 in FIG. 8 based on the control program 59. The transmitter-receiver 56 in the master station 100 functions as the parameter information transmitter 127 in FIG. 8. The master station 100 implements the functions of the unit information acquirer 121, the IP address assigner 122, the network structure information updater 123, the transmission-reception information determiner 124, the unit replacement determiner 125, the parameter information generator 126, and the parameter information transmitter 127 in FIG. 8 described above, with the controller 51 using the main storage 52, the external storage 53, and the transmitter-receiver 56 as resources. For example, the master station 100 performs determining whether a remote unit is replaceable with another remote unit with the unit replacement determiner 125, generating the parameter information with the parameter information generator 126, and transmitting the parameter information with the parameter information transmitter 127.

### Hardware Configurations of First Remote Unit 300 and Second Remote Unit 400 According to Embodiment 2

The transmitter-receiver 56 in each of the first and second remote units 300 and 400 functions as the parameter information receiver 304 or 404 in FIG. 8. Each of the first and second remote units 300 and 400 implements the functions of the operation mode setter 301 or 401, the connection combination determiner 302 or 402, the unit information notifier 303 or 403, and the parameter information receiver 304 or 404 in FIG. 8, with the controller 51 using the main storage 52, the external storage 53, and the transmitter-receiver 56 as resources. For example, each of the first and second remote units 300 and 400 performs receiving the parameter information with the parameter information receiver 304 or 404.

### Details of Functional Components of Master Station 100 According to Embodiment 2

The unit replacement determiner 125 determines whether the first and second remote units 300 and 400 can replace another remote unit and the expansion unit 700 based on the unit information acquired by the unit information acquirer 121 and the network structure information updated by the network structure information updater 123. The unit replacement determiner 125 compares the information for identifying the unit type and the number of connectable devices included in the unit information with the unit type information, the transmission setting information, and the reception setting information included in the updated network structure information to determine whether the combination with the unit type or the number of connectable devices is inappropriate.

For example, when the unit type indicated in the updated network structure information includes the input-output or includes the input and output, but the unit type indicated in the unit information is output alone, the unit replacement determiner 125 determines that the replacement cannot be performed. For example, when the total number of connectable devices indicated in the updated network structure information is 64 and the total number of connectable devices indicated in the unit information is 32, the unit replacement determiner 125 determines that the replacement cannot be performed. In this case, the master station 100 may output an indication of an error occurring in the field network 200.

When the first and second remote units 300 and 400 replace the third remote unit 600 and the expansion unit 700, the parameter information generator 126 generates the parameter information based on the acquired unit information and the updated network structure information. In the present embodiment, the master station 100 receives in advance, from the master station 100, the parameter information of the first, second, and third remote units 300, 400, and 600 generated by the user using the engineering tool 500. Thus, the parameter information generator 126 updates the parameter information stored in the master station 100 based on the unit information and the updated network structure information to generate new parameter information.

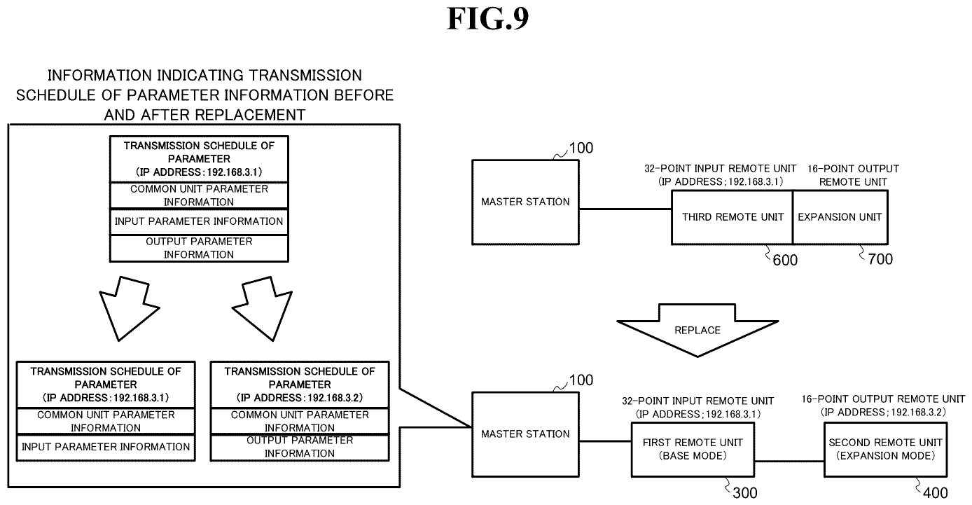

In the present embodiment, the parameter information includes information for identifying whether the operation mode of the first or second remote unit 300 or 400 is the base mode or the expansion mode, and information for identifying the connection combination of the first and second remote units 300 and 400. As illustrated in FIG. 9, the parameter information also includes common unit parameter information indicating a common unit parameter independent of the unit type, and input-output parameter information indicating an input parameter and an output parameter dependent on the unit type. The input-output parameter information includes input parameter information indicating the input parameter and output parameter information indicating the output parameter. The input parameter information and the output parameter information indicate parameters set for each of the connected input and output devices.

With the unit type of the third remote unit 600 to which the expansion unit 700 is connected being the input-output, the parameter information of the third remote unit 600 includes the common unit parameter information and the input-output parameter information including the output parameter information of the expansion unit 700. Thus, when the third remote unit 600 receives the parameter information, the expansion unit 700 can refer to the common unit parameter information indicated by the parameter information and the output parameter information of the expansion unit 700 for operation.

With the unit type of the first remote unit 300 to replace the third remote unit 600 being the input, the parameter information of the first remote unit 300 includes the common unit parameter information and the input parameter information. With the unit type of the second remote unit 400 to replace the expansion unit 700 being output, the parameter information of the second remote unit 400 includes the common unit parameter information and the output parameter information.

The parameter information transmitter 127 transmits the parameter information of each of the first and second remote units 300 and 400 generated by the parameter information generator 126 to the first or second remote unit 300 or 400. In the present embodiment, the user performing replacement uses the engineering tool 500 to transmit, to the CPU 110, information indicating the first and second remote units 300 and 400 to which the parameter information is to be transmitted. Thus, when the power is turned on and the initial setting of the field network 200 is performed after replacement, the parameter information transmitter 127 transmits the parameter information to each of the first and second remote units 300 and 400 indicated by the information received by the CPU 110.

In the present embodiment, when updating the network structure information, the network structure information updater 123 also updates, based on the updated network structure information, information indicating a schedule for transmitting the parameter information described above. In this case, as illustrated in FIG. 9, the network structure information updater 123 updates the information to indicate that the common unit parameter information is to be transmitted to all the replacing first and second remote units 300 and 400. In contrast, the network structure information updater 123 updates the information to indicate that the input parameter information in the input-output parameter information is to be transmitted to the first remote unit 300 alone, and the output parameter information in the input-output parameter information is to be transmitted to the second remote unit 400 alone.

### Details of Functional Components of First Remote Unit 300 and Second Remote Unit 400 According to Embodiment 2

Each of the parameter information receivers 304 and 404 receives the parameter information of the first or second remote unit 300 or 400 transmitted from the master station 100.

Each of the operation mode setters 301 and 401 sets the operation mode to one of the base mode or the expansion mode based on the parameter information received by the parameter information receiver 304 or 404. More specifically, each of the operation mode setters 301 and 401 identifying whether the operation mode of the first or second remote unit 300 or 400 is the base mode or the expansion mode based on the parameter information, and sets the operation mode.

Each of the connection combination determiner 302 and 402 determines the connection combination of the base unit and the expansion unit based on the operation modes of the first and second remote units 300 and 400 set by the operation mode setters 301 and 401 and the parameter information received by the parameter information receiver 304 or 404. More specifically, each of the connection combination determiner 302 and 402 identifies the connection combination of the first and second remote units 300 and 400 based on the parameter information, and determines the connection combination of the base unit and the expansion unit.

### Parameter Information Transmission Process in Embodiment 2

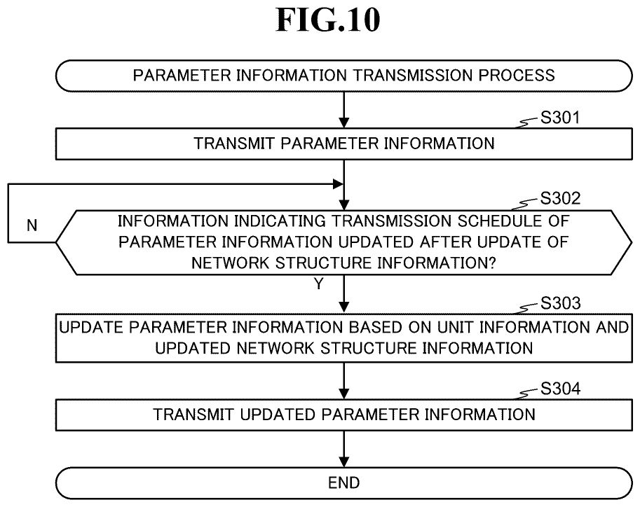

An operation for transmitting the parameter information generated by the master station 100 to the first, second, and third remote units 300, 400, and 600 is now described with reference to a flowchart. When turned on, for example, the master station 100 starts a parameter information transmission process illustrated in FIG. 10.

As illustrated in FIG. 10, the parameter information transmitter 127 transmits the parameter information generated by the user using the engineering tool 500 to each of the first and second remote units 300 and 400 based on the information indicating the schedule for transmitting the parameter information acquired from the engineering tool 500 (step S301).

After the parameter information is transmitted, the master station 100 determines whether the network structure information updater 123 has updated the network structure information and updated the information indicating the schedule for transmitting the parameter information (step S302). When the information indicating the schedule for transmitting the parameter information has not been updated (No in step S302), the master station 100 repeats the processing in step S302 until the information indicating the schedule for transmitting the parameter information is updated. When the information indicating the schedule for transmitting the parameter information has been updated (Yes in step S302), the parameter information generator 126 updates the parameter information based on the acquired unit information and the updated network structure information (step S303). After the parameter information is updated, the parameter information transmitter 127 transmits the updated parameter information to each of the first and second remote units 300 and 400 (step S304), and ends the process.

For the operation of the master station 100 to determine whether a remote unit is replaceable by another remote unit, the unit replacement determiner 125 simply determines whether the remote unit is replaceable by the other remote unit based on the unit information and the updated network structure information. The operation is thus not illustrated or described in detail to reduce redundancy.

As described above, in the PLC system 1 according to the present embodiment, the unit replacement determiner 125 in the master station 100 determines whether a remote unit is replaceable by another remote unit based on the acquired unit information and the updated network structure information.

This allows the PLC system 1 according to the present embodiment to detect an anomaly in the network structure updated after the remote unit is replaced by the other remote unit and the network structure information is updated.

In the PLC system 1 according to the present embodiment, when a remote unit is replaced by another remote unit, the parameter information generator 126 in the master station 100 generates, based on the acquired unit information and the updated network structure information, the parameter information to be used by each of the replacing first and second remote units 300 and 400. The parameter information transmitter 127 in the master station 100 transmits the generated parameter information, and each of the parameter information receivers 304 and 404 in the first or second remote unit 300 or 400 receives the parameter information.

This allows the master station 100 in the PLC system 1 according to the present embodiment to automatically generate and transmit the parameter information to be used by each of the replacing first and second remote units 300 and 400 to update the parameter information of each of the replacing first and second remote units 300 and 400.

In the PLC system 1 according to the present embodiment, the parameter information transmitter 127 in the master station 100 transmits the parameter information generated and transmitted by the user using the engineering tool 500. In each of the first and second remote units 300 and 400, the parameter information receiver 304 or 404 receives the parameter information transmitted from the master station 100. In each of the first and second remote units 300 and 400, the operation mode setter 301 or 401 sets the operation mode based on the received parameter information, and the connection combination determiner 302 or 402 determines the connection combination of the base unit and the expansion unit based on the received parameter information.

In this manner, each of the first and second remote units 300 and 400 can set the operation mode and determines the connection combination based on the parameter information generated by the user using the engineering tool 500. This allows each of the first and second remote units 300 and 400 to set the operation mode and determine the connection combination without using the H/W switches included in the first or second remote unit 300 or 400.

### Modifications

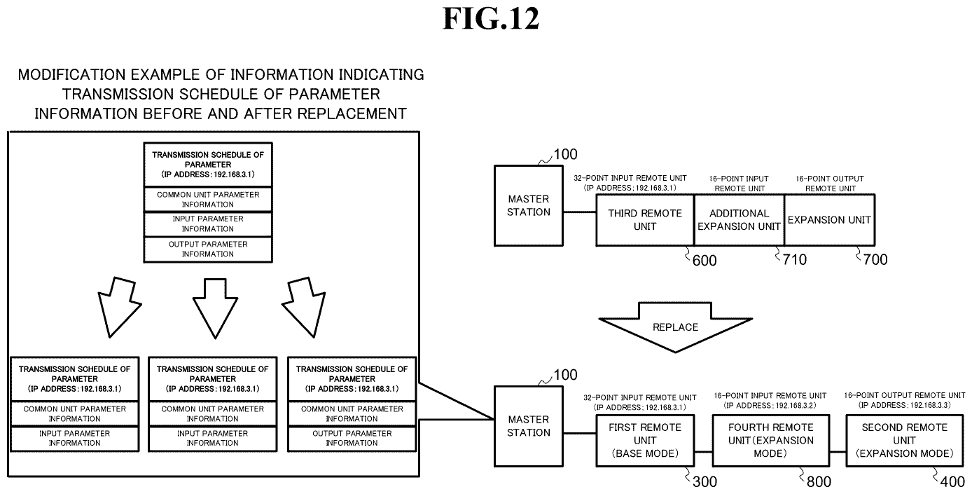

In Embodiments 1 and 2 described above, the single second remote unit 400 usable as the base unit replaces the single expansion unit 700, but multiple remote units may replace multiple expansion units. As illustrated in FIG. 12, for example, when the expansion unit 700 and an additional expansion unit 710 are connected to the third remote unit 600, a fourth remote unit 800 may replace the additional expansion unit 710.

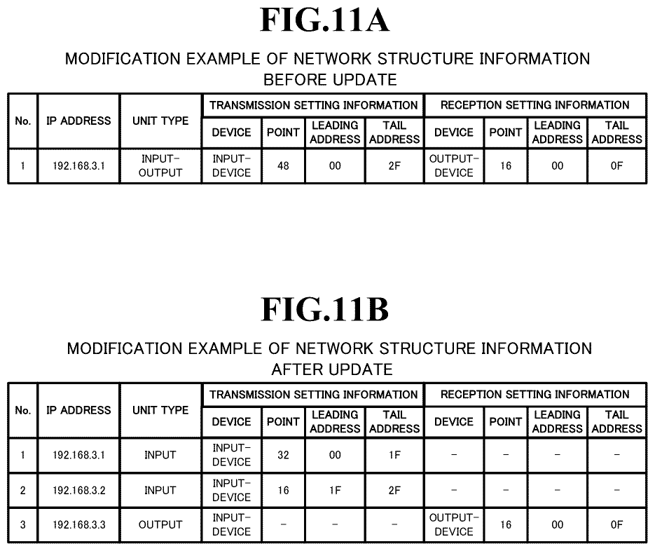

In this case, for example, when the additional expansion unit 710 is a 16-point input remote unit, the whole third remote unit 600 is an I/O remote unit with a total of 48 input points and 16 output points. Thus, in the pre-update network structure information illustrated in FIG. 11A, the value of the point is 48 and the value of the tail address is 2F in the transmission setting information. In the updated network structure information illustrated in FIG. 11B, for example, as illustrated in FIG. 5, for example, the value of the number being the identification information of the fourth remote unit 800 replacing the additional expansion unit 710 is 2, and the value of the number being the identification information of the second remote unit 400 replacing the expansion unit 700 is 3.

In the updated network structure information, for example, the value of the IP address being the IP address information of the fourth remote unit 800 is 192.168.3.2, and the value of the IP address being the IP address information of the second remote unit 400 is 192.168.3.3. In the updated network structure information, for example, the value of the unit type being the unit type information of the fourth remote unit 800 is the input. In the transmission setting information of the fourth remote unit 800, the value of the device is the input-device, the value of the point is 16, the value of the leading address is 1F, and the value of the tail address being the tail address of the devices is 2F.

In this case, as illustrated in FIG. 12, the network structure information updater 123 updates the information to indicate that the common unit parameter information is to be transmitted to all the replacing first, second, and fourth remote units 300, 400, and 800. In contrast, the network structure information updater 123 updates the information to indicate that the input parameter information in the input-output parameter information is to be transmitted to the first and fourth remote units 300 and 800, and the output parameter information in the input-output parameter information is to be transmitted to the second remote unit 400 alone.

In Embodiment 2 described above, the unit replacement determiner 125 determines whether a remote unit is replaceable by another remote unit based on the unit information and the updated network structure information, but the structure is not limited to this example. For example, the unit replacement determiner 125 may determine whether a remote unit is replaceable by another remote unit based on the unit information and the pre-update network structure information. In this case, the master station 100 may output an indication of an error occurring in the field network 200 preventing the update of the network structure information.

The main parts of the master station 100, the first remote unit 300, and the second remote unit 400 each including the controller 51, the main storage 52, the external storage 53, an operation device 54, the transmitter-receiver 56, and the internal bus 50 may be implemented by installing the program for the above operations stored and distributed in a non-transitory recording medium, such as a flash memory, readable by the master station 100, the first remote unit 300, and the second remote unit 400. This allows the master station 100, the first remote unit 300, and the second remote unit 400 to perform the processes described above. Such a program may be stored in a storage included in a server device on a communication network such as a local area network (LAN) or the Internet, and may be downloaded by the master station 100, the first remote unit 300, and the second remote unit 400 to implement the functions of the master station 100, the first remote unit 300, and the second remote unit 400.

When the functions of the master station 100, the first remote unit 300, and the second remote unit 400 are implementable partly by the operating system (OS) and application programs or through cooperation between the OS and the application programs, portions executable by the application programs may be simply stored in a non-transitory recording medium or a storage device.

The program may be superimposed on a carrier wave to be distributed through a network. For example, the computer program may be posted on a bulletin board system (BBS) on the communication network to be provided through the communication network. The computer program may be activated and executed under the control of the OS in the same manner as another application program to perform the above processes.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 PLC system
50 Internal bus
51 Controller
52 Main storage
53 External storage
56 Transmitter-receiver
59 Control program
100 Master station
110 CPU
120 Master unit
121 Unit information acquirer
122 IP address assigner
123 Network structure information updater
124 Transmission-reception information determiner
125 Unit replacement determiner
126 Parameter information generator
127 Parameter information transmitter
200 Field network
300 First remote unit
301, 401 Operation mode setter
302, 402 Connection combination determiner
303, 403 Unit information notifier
304, 404 Parameter information receiver
400 Second remote unit
500 Engineering tool
600 Third remote unit
700 Expansion unit
710 Expansion unit
800 Fourth remote unit

1. A programmable logic controller system, comprising:
a master station including a central processing unit and a master unit; and
a plurality of remote units to transmit and receive information to and from the master station through a network,
wherein the central processing unit controls devices connected to the plurality of remote units,
each of the master unit and the plurality of remote units includes processing circuitry and a transmitter-receiver,
the processing circuitry of each of the plurality of remote units
sets an operation mode to one of a base mode or an expansion mode based on an operation performed by a user, the base mode being an operation mode in which the remote unit operates as a base unit connected to the network to transmit and receive information to and from the master station, the expansion mode being an operation mode in which the remote unit operates as an expansion unit for the base unit, and
determines, based on the set operation mode, a connection combination of a base unit and an expansion unit,
the transmitter-receiver of each of the plurality of remote units
provides, to the master station, unit information about the remote unit, the unit information including connection combination information for identifying the connection combination determined by the processing circuitry of the remote unit,
the transmitter-receiver of the master station
acquires the unit information of a remote unit of the plurality of remote units, and
the processing circuitry of the master station
assigns an internet protocol address to the remote unit based on the unit information acquired by the transmitter-receiver of the master station and network structure information indicating a structure of the network,
updates the network structure information based on the assigned internet protocol address and the unit information acquired by the transmitter-receiver of the master station, and
determines, based on the updated network structure information a format of information to be transmitted by the master station to the remote unit and a format of information to be received by the master station from the remote unit.

2. The programmable logic controller system according to claim 1, wherein
the processing circuity of the master station determines whether a remote unit of the plurality of remote units is replaceable by another remote unit of the plurality of remote units based on the unit information acquired by the transmitter-receiver of the master station and the updated network structure information.

3. The programmable logic controller system according to claim 1, wherein
the processing circuity of the master station
generates, when a remote unit of the plurality of remote units replaces another remote unit of the plurality of remote units, parameter information indicating a parameter to be used by the replacing remote unit based on the unit information acquired by the transmitter-receiver of the master station and the updated network structure information,
the transmitter-receiver of the master station
transmits the parameter information generated by the processing circuity of the master station, and
the transmitter-receiver of each of the plurality of remote units receives the parameter information.

4. A remote unit for transmitting and receiving information to and from a master station in a programmable logic controller system through a network, the master station including a central processing unit and a master unit, the remote unit being connected to a device controllable by the central processing unit, the remote unit comprising:
processing circuitry; and
a transmitter-receiver, wherein
the processing circuitry
sets an operation mode to one of a base mode or an expansion mode based on an operation performed by a user, the base mode being an operation mode in which the remote unit operates as a base unit connected to the network to transmit and receive information to and from the master station, the expansion mode being an operation mode in which the remote unit operates as an expansion unit for the base unit,
determines, based on the set operation mode, a connection combination of a base unit and an expansion unit,
provides, to the master station, unit information about the remote unit, the unit information including connection combination information for identifying the determined connection combination,
assigns the internet protocol address assigned by the master station based on the unit information and network structure information indicating a structure of the network, and
the transmitter-receiver transmits and receives information to and from the master station in a format determined by the master station based on the network structure information updated by the master station based on the internet protocol address and the unit information.

5. A master station in a programmable logic controller system, the master station including a central processing unit and a master unit to control devices connected to a plurality of remote units to transmit and receive information through a network, the master station comprising:
processing circuitry; and
a transmitter-receiver, wherein
the transmitter-receiver acquires unit information about the remote unit, the unit information including connection combination information for identifying a connection combination of a based unit connected to the network determined by the remote unit to transmit and receive information to and from the master station and an expansion unit for the base unit, and
the processing circuitry
assigns an internet protocol address to the remote unit based on the unit information acquired by the transmitter-receiver and network structure information indicating a structure of the network,
updates the network structure information based on the assigned internet protocol address and the unit information acquired by the transmitter-receiver, and
determines, based on the updated network structure information, a format of information to be transmitted by the master station to the remote unit and a format of information to be received by the master station from the remote unit.

6-9. (canceled)

10. The programmable logic controller system according to claim 2, wherein
the processing circuity of the master station
generates, when a remote unit of the plurality of remote units replaces another remote unit of the plurality of remote units, parameter information indicating a parameter to be used by the replacing remote unit based on the unit information acquired by the transmitter-receiver of the master station and the updated network structure information,
the transmitter-receiver of the master station
transmits the parameter information generated by the processing circuitry of the master station, and
the transmitter-receiver of each of the plurality of remote units
receives the parameter information.
